(19) United States
(12) Patent Application Publication
(10) Pub. No.: US 2005/0160935 A1
(43) Pub. Date: Jul. 28, 2005

(54) Method for analysis of label positioning and printed image to identify and correct printing anomalies

(76) Inventors: William Armstrong, Snohomish, WA (US); Kathy McCready, Snohomish, WA (US)

Correspondence Address: ORUM & ROTH, 53 W. JACKSON BLVD., CHICAGO, IL, 60604, US

(21) Appl. No.: 10/944,477

(22) Filed: Sep. 17, 2004

Related U.S. Application Data
(60) Provisional application No. 60/504,410, filed on Sep. 18, 2003.

(51) Int. Cl. B41F 13/02; B65H 23/00

(52) U.S. Cl. 101/485

(57) ABSTRACT

A printing device with one or more data capture device. The captured data is used to determine anomalies stet system. Using pattern recognition, image quality verification, and position recognition irregular labels can be discarded and adjustments made to correct for the anomalies and/or reset the printer. A method for using the printing device to analyze the label position and printed image to identify and correct the anomalies.

This application claims the benefit of U.S. Provisional Application 60/504,410 entitled A Method For Analysis of Label Positioning and Printed Image to Identify and Correct Printing Anomalies, filed Sep. 18, 2003.

### BACKGROUND OF THE INVENTION

1. Field of the Invention

The present invention relates to bar code printers. Specifically, the present invention relates to a method for analysis of label position and printed image to correct printing anomalies due to mechanical, software and/or electrical issues.

2. Description of the Prior Art

Approximately 10-20% of bar code printer users, use applications which make use of labels with printed bar codes. A key requirement for these applications is that the label will repeatedly present the bar code in the same area to allow an applicator to pick it up or a bar code reader or scanner to read it.

Prior art verifiers relied on visual inspection by operators or scanning a bar code td determine if it can be read. Another prior art system uses a verifier associated with a printer having a controller.

### SUMMARY OF THE INVENTION

Analysis of the image on a printed label is used to identify printing anomalies due to mechanical, software and/or electrical issues. The position, quality and image-to-image variation may be analyzed. The printer auto corrects for the identified anomalies.

A device such as a verifier or scanner is used to capture data. The device may be external or internal to the printer. More than one device can be used depending on the data capture capability of the device. A combination of devices such as laser scanner or an imager with different capabilities could also be used to capture data relative to the printed label.

An image produced by any technique such as thermal printing, color printing, laser printing, or thermal etch templates, and/or the positioning, and functionality of an RFID etc. is captured and analyzed. The captured data is used to determine anomalies relative to the printing system. Anomalies related to label position, RFID tag position, image quality and image-to-image variation can be identified.

One or more devices are set up to recognize the same pattern produced repeatedly. The scanning device(s) recognizes any changes to the pattern using pattern recognition. The pattern changes may be due to mechanical, software and/or electrical issues. For example, with respect to a mechanical issue, the change in pattern could be due to compressed printing, motor stalling, ribbon wrinkling (alignment), or part of the printed image could be missing off the label (registration).

The data capture device is also capable of recognizing a change in the position, of the label (position recognition). The captured position information is used to repeatedly present a label in the same present position. Position recognition can also be used to recognize the change in position of the printed image or an RFID tag relative to the label.

### BRIEF DESCRIPTION OF THE DRAWINGS

FIG. 1 shows a printer.

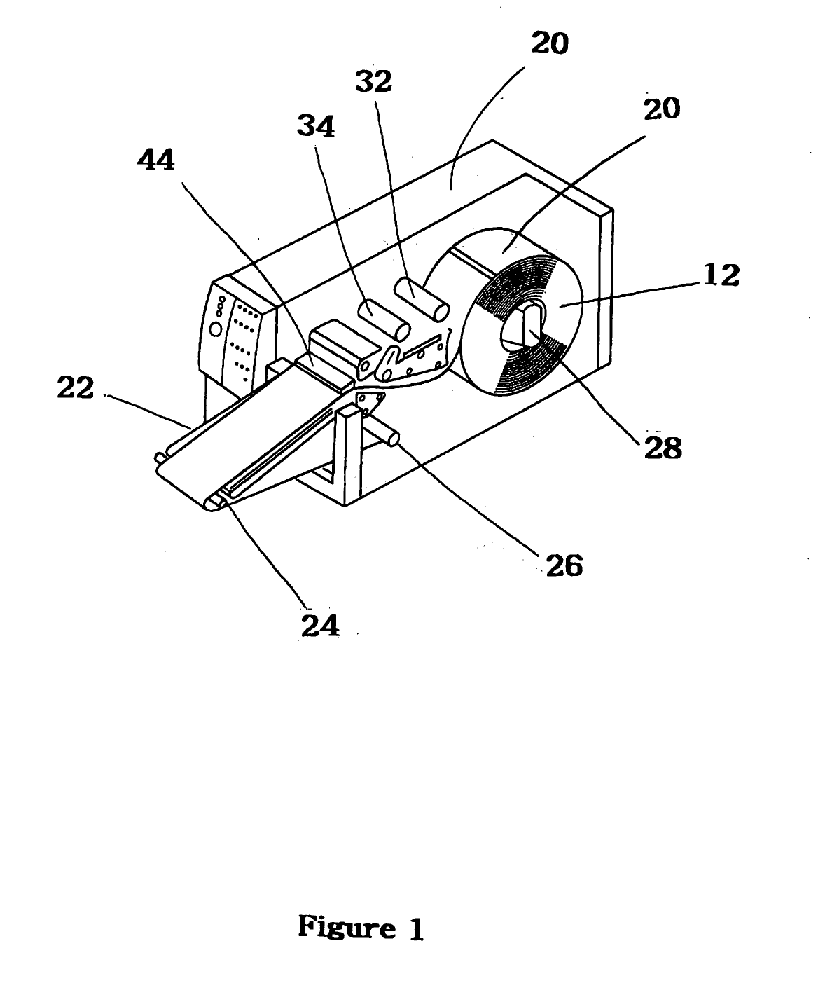

FIG. 2 shows a side view of a printer with scanning devices.

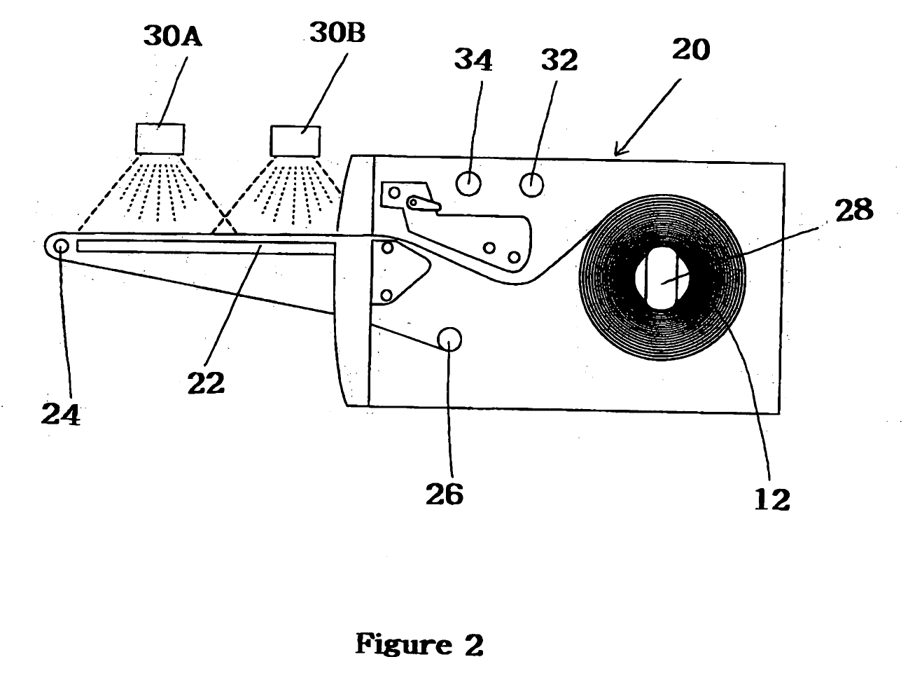

FIG. 3 shows a top view of the printer with scanning devices of FIG. 2.

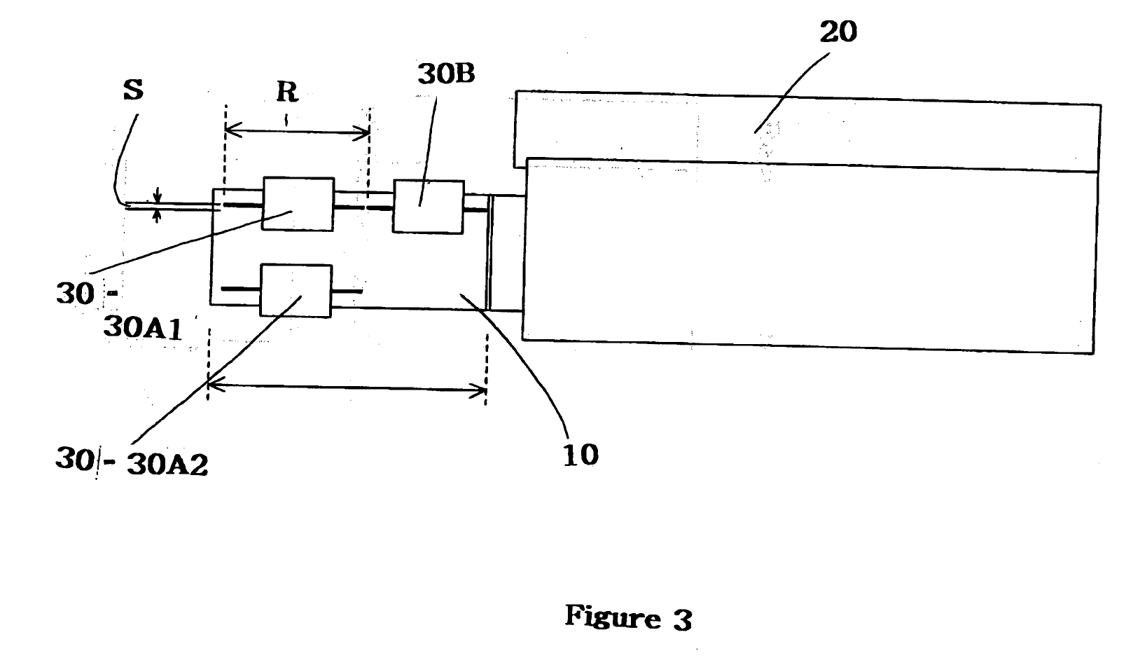

FIG. 4 shows a printer with scanner devices.

### DETAILED DESCRIPTION OF THE INVENTION

Analysis of a printed label 10 is used to identify printing anomalies due to mechanical, software and/or electrical issues. Once an anomaly is identified, the printer 20 can auto correct for that anomaly. Preferably, position, quality and image-to-image variation analysis are used. Analysis may be made of an image produced by any method such as thermal printing color printing, laser printing, thermal etch templates. An analysis of RFID positioning and functionality etc. is also possible.

A device such as a verifier or scanner 30 is used to capture data. The device may be internal or external to the label printer 20. More than one device 30 may be used depending on the data caption capability of the device. The scanner can either capture the entire label 10 or a slice of the label as it leaves the print station. If the scanner 30 captures a label slice, it is preferable that the slice is of sufficient resolution to capture pixels relative to 200, 300, and 400 dpi densities for printed images.

The captured data is used to determine anomalies relative to the printing system including label position, RFID tag position, image quality and image-to-image variation. If one or more devices 30 are set up to recognize the same pattern printed repeatedly, the device would recognize any changes, deviations or anomalies in the pattern, i.e. pattern recognition. Mechanical, software and electrical issues cause pattern changes. For example, if the motor stalls, it would cause compressed printing. If the ribbon 40 wrinkles it might result in the alignment being off. If the registration of the machine 20 is not correct, part of the printed image will be missing off the label 10. Software and/or electrical issues cause similar anomalies in the pattern.

Preferably, the data capture device 30 is also capable of recognizing a change in position of the label 20. This is known as position recognition. It is not necessary for a printed image to be on the label for the scanning device 30 to recognize the position of the label 20. Captured position information is used to insure that the label 20 is repeatedly presented in the same present position. This is especially important when using labels 10 in conjunction with an applicator. As the label 20 moves toward the present position, i.e. the position where it will be presented to the applicator, the label position is captured relative to a precisely positioned tool. If the present position of the label 10 varies relative to the tolerance requirement of the applicator, the scanner 30 reports the new position with applicable dimensions to the printer 20. The printer 20 software calculates required adjustments to meet the present position baseline. This adjustment information is translated to the motor. The information is used to move the label 10 forward or backward until it is in the baseline position for the applicator.

The calculations and processes are carried out within a specific time frame to insure that the label 10 is always in the established baseline present position by the time the applicator moves to pick up the label. Due to small tolerances, the appropriate present position of a label 10 cannot be identified visually, especially for smaller labels. The position recognition approach is also used to verify the RFID tag position from label to label. The failure of a label 10 to be in the right present position may cause the applicator to miss picking up the label or apply the label out of tolerance. A mislabel may result in unlabeled parts, parts with an out of position label, or conveyor belt shutdowns. Any of which leads to higher costs, dissatisfies customers and may result in loss of business.

If image quality verification is used, quality and label position verification becomes a two-step process. The first step is image quality verification and label position, capture. If then image quality passes, in the second step the label position information is used to modify the present position of the label 10. If the image quality fails, the label position information is discarded and the first step is repeated for the next label 10. This continues until an image is produced that passes image quality verification. Any device 30 can be used that will detect the label position relative to a frame of reference and communicate adjustments required to the printer.

Position recognition can also be used to recognize a change in position of the image relative to the label 10. The produced image may shift position or stretch on the label 10. A data capture device 30 is used to establish the position of the printed image relative to the label. The scanner 30 captures changes in the side to side (laterals, forward and backward, and skew positions. More than one scanner 30A, 30B may be used depending on the data capture capability of the device. The scanner 30 may capture the entire label or a slice of the label as it leaves the print station. The slice needs to be a sufficient resolution relative to 200, 300 and 400 dpi densities for the printed image.

Position and pattern recognition information is captured by one or more scanner devices 30 or a combination of devices 30 that capture the entire label or a slice of the labels. The number of scanners required to capture information depend on the length of the label and the amount of data being captured.

For larger labels 10, a porch 22 is required to keep the label 10 flat when the scanner 30 captures the image. A label assist roller 24 can be positioned at the end of the porch 22 to assist the label back to the batch take up 26.

In an alternative embodiment, capturing information on pattern and position recognition may be done for a large label 10 such as a 4×6 label. For large labels, image capture set up may require several scanners 30A1, 30A2, 30B. For example, three scanner devices such as CCD scanners may be used. Two scanners 30A1, 30A2 would be placed side by side at an inboard location with a third scanner 30B behind sand parallel to the first inboard scanner 30A1. The first scanner 30A1 captures the inboard label location and image data. The second scanner 30A2 captures the outboard label location and image data. The third scanner 30B captures the location and image data on the back half of the label 10 on the inboard side. The position data is captured relative to a precisely positioned tool (present position calibration) or the leading ledge of the label (printed image calibration). The image data used is for pattern recognition. The data is captured when the label stops. If the printer is in batch take up print mode the label will continue its travel to the batch take up hub 26 after the data is captured. If the printer is in self-strip print mode, the label will be removed after the present position is modified and the liner will continue to be taken up on the batch take up hub 26.

The front inboard scanner 30A1 is capable of capturing data at three points. The front inboard scanner 30A1 can capture the leading edge of the label to a precisely placed tool to measure the present position. The leading edge of the label to leading edge of the image for location recognition measurements. The leading edge of the image to the trailing edge of the image. If the printed image is too large for the front inboard scanner, another scanner is required at the back inboard position 30B. The main goal of the front inboard scanner 30A1 is to measure the distance from the leading edge of the label to the leading edge of the printed image for location recognition.

A device 30 that captures position and pattern data is a powerful tool with unlimited capabilities. The top of form (TOF) switch on a printer where a sensor and a software algorithm determine start of print and label length. Using a box format that outlines the inboard edges of the label, the operator can toggle the TOF switch to adjust the starting and ending position of the box. The TOF switch, which requires an operator, can be automated by replacing the sensor with data capture device.

A data capture device or sensor 30 can also be used to automatically set up the printer 20. Media 12 has operating specifications including imaging energy and maximum print speed. The first label 10 on each roll of media 12 could contain the setup information in a linear or 2D symbology or other coding method. A sensor or data capture device 30 would “read” this information and setup the printer 20 accordingly. The setup information could also be sent to the printer 20 using an RFID read/write device.

A typical thermal transfer printer has a print media 12 on a media hub 28. The media is often a label on a liner. The media 12 is printed with thermal transfer ribbon 42 at the printhead 30. The ribbon 42 is located on the ribbon supply hub 32 and the used ribbon rewinds on the empty ribbon/ribbon rewind hub 34.

There is a head lift lever 36 which can be used to adjust the printhead 44 pressure. The printer has a TTR assist roller.

For large labels 10 such as 4×6 inch labels the printer can have porch 22 or other horizontal label support 22. The porch can have a label assist roller. The liner of the label is rewound onto a batch take up hub 26 after the label 10 is removed. Alternatively, printed labels could be rewound for later use.

In one embodiment of the present invention, the printer 20 has two and sometimes three associated scanners 30A1, 30A2, 30A. Preferably, there are two scanners at the front. One at the front inboard position 30A1 and one at the front outboard position of the label 30A2. If the label is too large a third scanner 30B is located at a back inboard position.

The front inboard scanner 30A1 is capable of capturing three data points:
d. Leading edge of label to precisely measure the present position.
e. Leading edge of label to leading edge of image for location recognition measurement.
f. Leading edge of image to trailing edge of image.
   The scanner captures a thin slice S of the data over a large range R. The main purpose of the front outboard scanner 30A1 is to measure distance from leading edge of label to leading edge of printed image for location recognition.

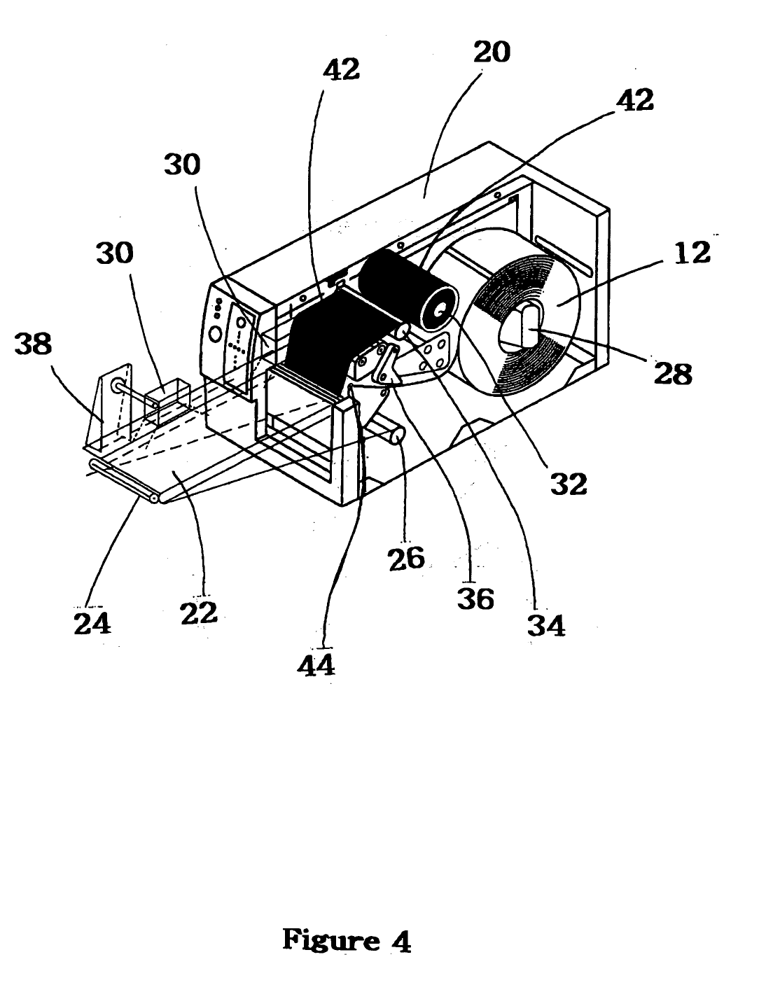

In an alternative embodiment the printer 20 can have one or more associated scanners 30A1, 30A2, 30B. As shown in FIG. 4, the scanner can be internal to the printer external or a combination of internal and external scanners. In one embodiment, the scanner is attached to a vertical support 38 that is attached to the porch 22.

In one embodiment, a reference pattern or mark(s) is machined into the porch 22 in view of the scanner with the label in the operational position. Alternatively, the reference pattern or marks could be printed on the porch 22 or applied in any other known manner,

1. A method of identifying and correcting anomalies comprising the steps of:
capturing media data from at least a slice of a label as the label leaves a print station,
determining printing anomalies relative to the printing system,
determining any changes in a pattern on the media:
marking or discarding any media with a printing anomaly and/or a pattern change,
recognizing any change in position of the media,
if a change in position is recognized, calculating required adjustments to a baseline position and moving the media forward or backward to a baseline position.

2. A printer that automatically adjusts for anomalies comprising of:
a printer,
at least one data capture device adapted to capture data from the printed media,
the data capture device located such that data is captured as the media it leaves the printer, and
a controller with software electronically connected to the data capture device.

3. The method of claim 1 wherein print anomalies and/or changes in pattern are determined before a change in position is recognized.

4. The method of claim 1 wherein media data is captured by at least one scanner.

5. The method of claim 2 wherein media data is captured by a plurality of scanners.

6. The method of claim 4 further comprising the step of scanning a media range and capturing data for a label slice with the at least one scanner.

7. The method of claim 5 further comprising the step of scanning media range and capturing data for a media slice for each of the plurality of printers.

8. The method of claim 1 further comprising comparing label data with a know image pattern to identify the changes in pattern.

9. The method of claim 1 further comprising the step of determining whether the anomaly is due to mechanical, software and/or electrical issues based on the determined pattern change.

10. The method of claim 9 wherein the mechanical issue is identified as motor stalling when the change in pattern is compressed printing.

11. The method of claim 9 wherein the mechanical issue is identified as ribbon wrinkling, alignment, or registration.

12. The method of claim 1 further wherein the media is labels and comprising the further step of repeated presenting the labels at a present position based on the captured position information.

13. The method of claim 1 further comprising the steps of recognizing a change in position of the printed image or an RFID tag relative to the media and adjusting the printer to correct the change in position.

14. The method of claim 1 further comprising the steps of capturing printer set-up information from a particular media with a data capture device and setting the printer settings based on printer set-up information.

15. The printer of claim 2 further comprising software to automatically adjust media registration.

16. The printer of claim 2 further comprising software to automatically adjust the present position.

17. The printer of claim 2 further comprising a media support under the at least one data capture de vice.

18. The printer of claim 2 further comprising media having set-up information, wherein the data capture device is adapted to capture the set-up information and the printer is adapted to be automatically set-up based on the captured set-up information.

19. The printer of claim 2 wherein the at least data capture device comprises a front inbound scanner, a front outbound scanner and a back inbound scanner and said scanners are positioned to scan at least a slice of a printer media.

20. The printer of claim 2 wherein the at least one data capture device comprises at least two scanners positioned to scan at least a slice of a printer media.
